(19) United States
(12) Patent Application Publication
(10) Pub. No.: US 2018/0160706 A1
(43) Pub. Date: Jun. 14, 2018

(54) DRY ICE BEVERAGE DELIVERY APPARATUS

(71) Applicant: TR Marketing, Inc., Irvine, CA (US)

(72) Inventor: Tareq Adel Risheq, Irvine, CA (US)

(73) Assignee: TR Markeing, Inc.

(21) Appl. No.: 15/376,993

(22) Filed: Dec. 13, 2016

(51) Int. Cl. A23L 2/54

(52) U.S. Cl. CPC A23L 2/54; A23V 2002/00

(57) ABSTRACT

A method and apparatus for providing dry ice with a beverage is provided. Providing dry ice with the beverage includes causing a vessel containing pressurized carbon dioxide to expel the pressurized carbon dioxide into a trap, thereby forming dry ice and opening the trap. Opening the trap exposes the dry ice formed to a liquid.

### BACKGROUND OF THE INVENTION

### Field of the Invention

The present invention relates generally to the art of high end beverage containers, and more specifically to methods and devices for providing dry ice with a beverage at a desired time.

### Description of the Related Art

People enjoy beverages that offer something different in their drinking experiences. One such novelty beverage item is exposing a beverage to dry ice, which in certain beverages can provide an unusual gas effect, looking like what some have called a white “fog,” typically heavier than air. Dry ice is the solid form of carbon dioxide having a temperature of minus 109.3 degrees Fahrenheit.

However, dry ice has certain issues. For one, exposure to human skin can cause frostbite, and providing dry ice for serving into beverages can provide storage issues in that dry ice stored in a conventional freezer next to ice or other frozen items may affect those other items adversely or may harm persons simply wishing to obtain a different item from the same freezer location.

Dry ice cannot easily be provided with a beverage on shipment. Placing dry ice with a beverage at time of shipment results in the ice and liquid moving toward room or storage temperature, i.e. the dry ice mixing with the beverage and producing the “fog” within the container. When the container is finally opened, the effect will have dissipated in most instances and/or be will be ineffectual.

Other dry ice devices include machines that produce dry ice in specially designed glasses. Another solution is a stick, i.e. a swizzle stick, having compartments for storing dry ice. These require the user to provide dry ice, and dry ice is not commonly available to most consumers.

Thus there is a need in the industry to provide for the use of dry ice in or with a beverage that provides a pleasing experience for the consumer while at the same time overcoming the issues with previous dry ice and beverage arrangements and devices.

### SUMMARY OF THE INVENTION

Thus according to one embodiment, there is provided an apparatus comprising a vessel containing pressurized carbon dioxide, the vessel having a closed opening formed therein, a trap connected to the vessel wherein, when the closed opening in the vessel is opened, carbon dioxide passes into the trap, forming dry ice, and a trap covering positioned with the trap to be in a closed position and configured to be opened, thereby exposing the dry ice formed in the trap.

According to a second embodiment, there is provided a beverage can comprising a liquid, a vessel containing pressurized carbon dioxide, the vessel having a closed opening formed therein, a trap connected to the vessel wherein, when the closed opening in the vessel is opened, carbon dioxide passes into the trap, forming dry ice, and a trap covering positioned with the trap to be in a closed position and configured to be opened, thereby exposing the dry ice formed in the trap. The liquid is exposed to the dry ice when the trap covering is opened.

According to a further embodiment, a method for providing dry ice with a beverage is provided. Providing dry ice with the beverage comprises causing a vessel containing pressurized carbon dioxide to expel the pressurized carbon dioxide into a trap, thereby forming dry ice and opening the trap. Opening the trap exposes the dry ice formed to a liquid.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 shows an exterior view of a can with a switch in accordance with one embodiment of the present design;

FIG. 2 is a cutaway view of a container or can according to one embodiment of the present design;

FIG. 3 is a cutaway view of the base of the can or container;

FIG. 4 is an alternate view of one embodiment of the design where the can is closed and carbon dioxide is sealed in the cartridge;

FIG. 5 shows a close view of the base of the can when the can is closed;

FIG. 6 is a view of a can with the switch turned 90 degrees, opening the can and screwing the carbon dioxide cartridge onto the pin, allowing carbon dioxide to pass to the trap;

FIG. 7 is an expanded view of FIG. 6 with an arrow showing direction of movement;

FIG. 8 shows the switch rotated further and the protrusions cutting the trap cover;

FIG. 9 shows an expanded view of cutting or opening of the trap cover, including an arrow representing direction of turning and fog formed in the can;

FIG. 10 shows the components of an alternate version of the present design;

FIG. 11 illustrates the can of the alternate embodiment and carbon dioxide sealed in the cartridge or vessel;

FIG. 12 is a close view of FIG. 11 showing a cross section of the trap, trap cover, vessel/cartridge, and related components;

FIG. 13 shows the can and switch rotated approximately 90 degrees in this alternate embodiment;

FIG. 14 is a closer view of FIG. 13 showing the direction of rotation;

FIG. 15 illustrates the dry ice formed using the alternate embodiment;

FIG. 16 shows the switch of the alternate embodiment turned an additional approximately 90 degrees such that the pin peels pack the trap cover, exposing dry ice to liquid provided inside the can; and

FIG. 17 shows the liquid beginning to bubble and fog beginning to build and pour out of the can in the alternate embodiment.

The exemplification set out herein illustrates particular embodiments, and such exemplification is not intended to be construed as limiting in any manner.

### DETAILED DESCRIPTION OF THE DISCLOSURE

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

The present design is a dry ice beverage container that separates dry ice from the beverage until a desired time, and when desired, allows the consumer to combine or release the dry ice into the beverage and pour the beverage from the container.

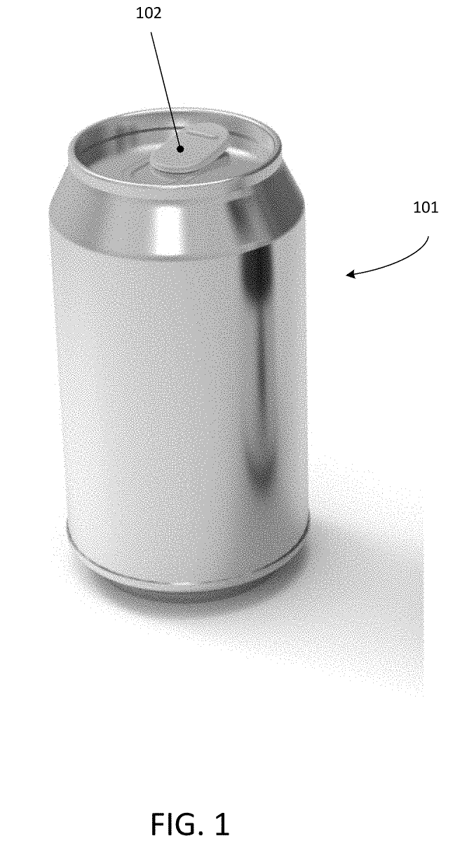

FIG. 1 shows an exterior view of can 101 with switch 102. The exterior of can 101 appears generally like a typical soda can and can be packed and shipped like any conventional can.

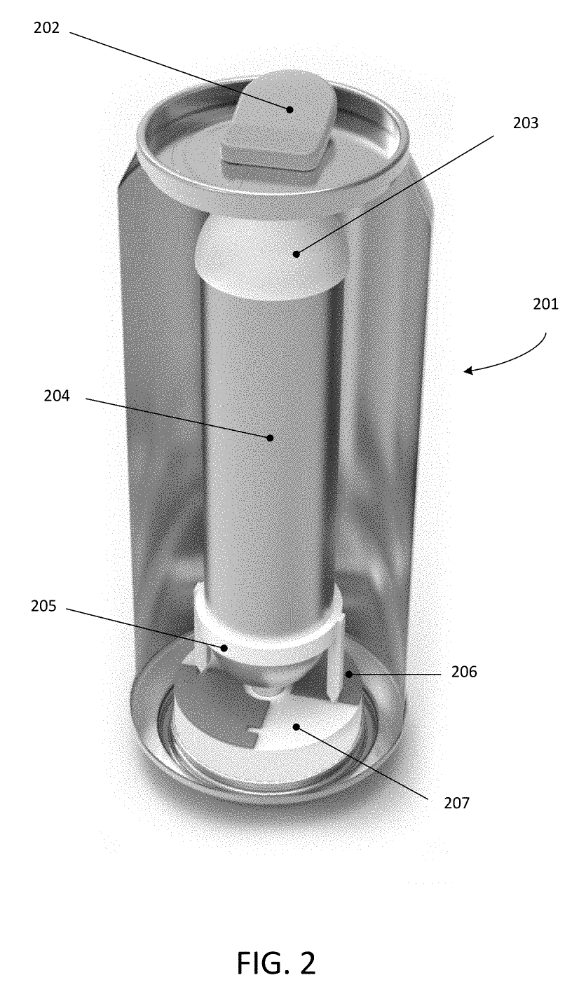

FIG. 2 is a cutaway view of a container 201 according to the present design. The basic concept is to keep the dry ice in an insulated container that is releasable by the consumer at a desired time, wherein release of the dry ice results in the beverage being exposed to the dry ice and being poured into a glass or other container. FIG. 2 illustrates switch 202 as well as carbon dioxide cap 203, carbon dioxide cartridge 204, and cutting ring 205. The present design uses compressed carbon dioxide and maintains the compressed carbon dioxide within carbon dioxide cartridge 204. Below cutting ring 205 is provided trap cover 206 and dry ice trap 207.

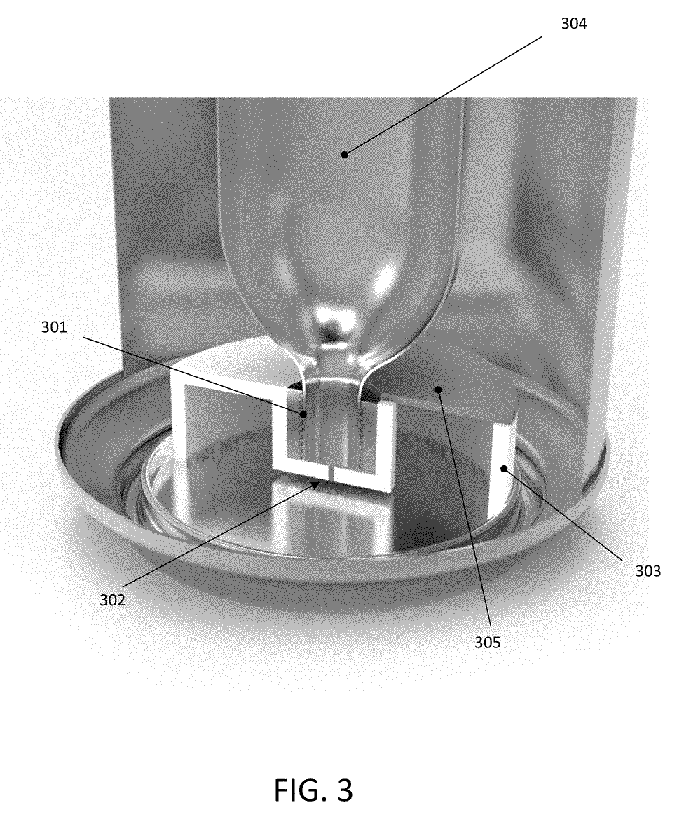

FIG. 3 is a cutaway view of the base of the can 101 in the present design. Shown is the bottom of carbon dioxide cartridge 304 having threads 301. Also shown is pin 302 and dry ice trap 303 as well as trap cover 305. Ice trap 303 has openings provided therein in this embodiment that are exposed when trap cover 305 is opened, in this embodiment, by cutting the trap cover 305 using the rotation of protrusions of cutting ring 205. Cutting of the trap cover 305, discussed in more detail below, exposes the dry ice formed in dry ice trap 303 to liquid contained in the can. The liquid is provided but not specifically shown in FIG. 3. Alternately, no liquid may be provided in the can, the can may be sealed, and creation of the dry ice using dry ice trap 303 occurs followed by pouring any desired liquid into the can.

As may be appreciated, rotation of the switch 102 causes exposure of an opening in the top of can 101. A seal may be provided between the switch 102 and the can 101 such that rotation of the switch breaks the seal and exposes the contents of the can to the atmosphere.

In operation, a consumer or user will turn switch 202, thereby rotating carbon dioxide cap 203 fixedly joined to carbon dioxide cartridge 204. This will also rotate cutting ring 205 and will screw the threads 301 attached to carbon dioxide cartridge 304 downward into pin 302. Pin 302 will puncture a surface provided at the bottom of threads 301 causing the pressurized carbon dioxide contained within carbon dioxide cartridge 204 to escape into the ice trap 303, forming dry ice. Further turning of switch 202 causes further rotation of the cutting ring 205, which as shown is an open circular piece having two downward protrusions in this embodiment, and the two downward protrusions serve to rotate the trap cover 305. The inside of the circle of cutting ring 205 is solidly bound or affixed to carbon dioxide cartridge 204. As a result, the switch 202, carbon dioxide cap 203, carbon dioxide cartridge 204, and cutting ring 205 and the protrusions of cutting ring 205 are fixedly mounted together such that rotation of the switch 202 rotates all the other components. The protrusions from cutting ring 205 may meet with or engage notches or other components formed in or by trap cover 206.

While shown in a particular orientation in FIG. 2, the protrusions and trap cover 206 may be provided in such a manner as to cause significant perforation by the pin 302 through the solid piece provided at the bottom of threads 301 and carbon dioxide cartridge 304, or only slight perforation by the pin through these components. Sizing and positioning of the pin, construction of the bottom of threads 301, rotation of the threads in a closed and open position, construction of the protrusions, material used in the trap cover 305, and other parameters may be variable and provide for an efficient delivery of the formed dry ice to the beverage/liquid, or simply the efficient creation of dry ice. In other words, different configurations are possible using the basic teachings of the design provided and claimed herein.

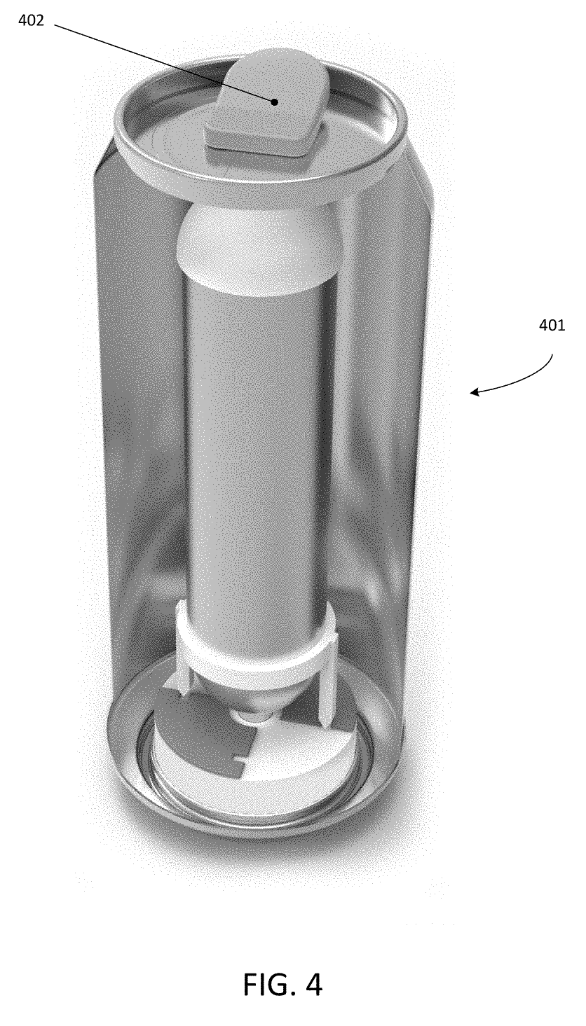

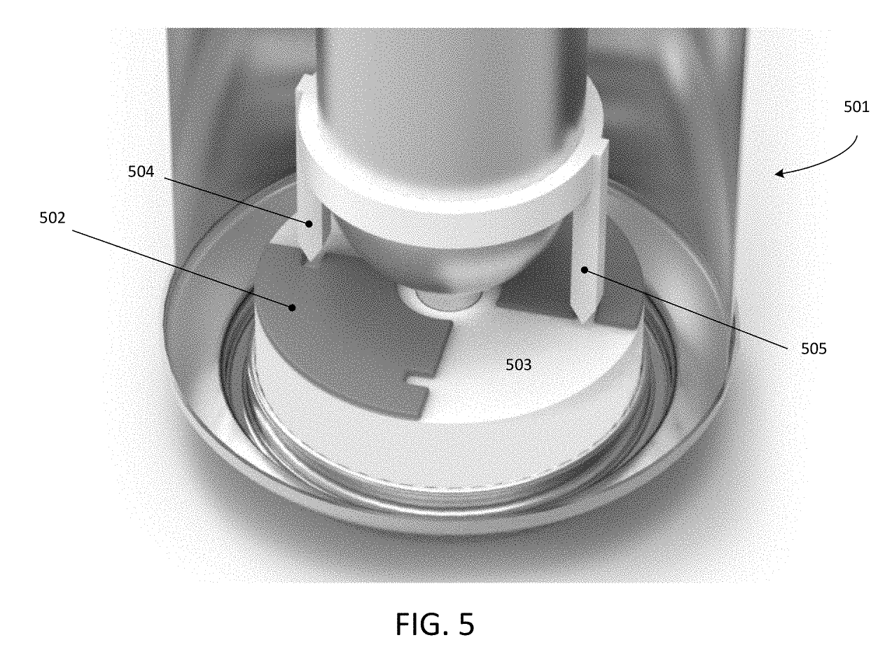

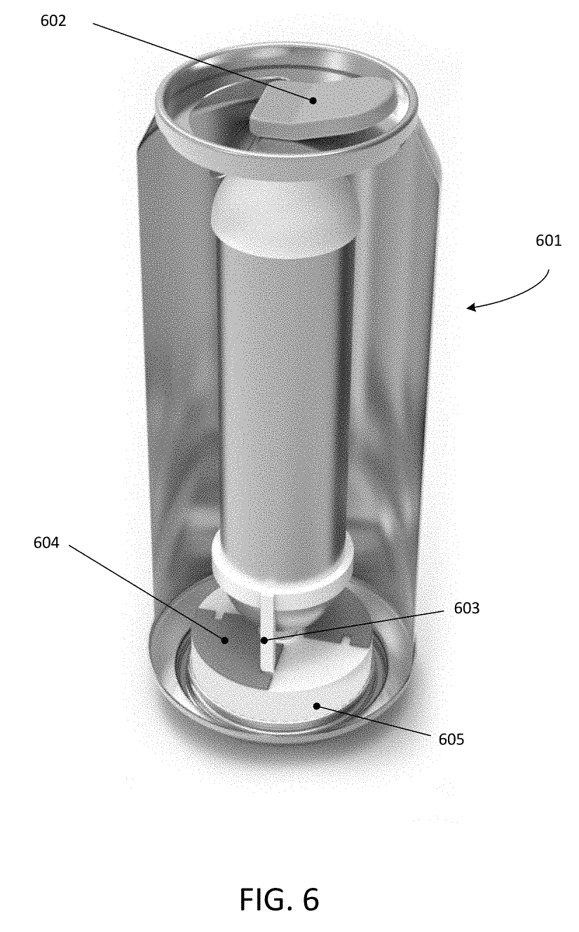

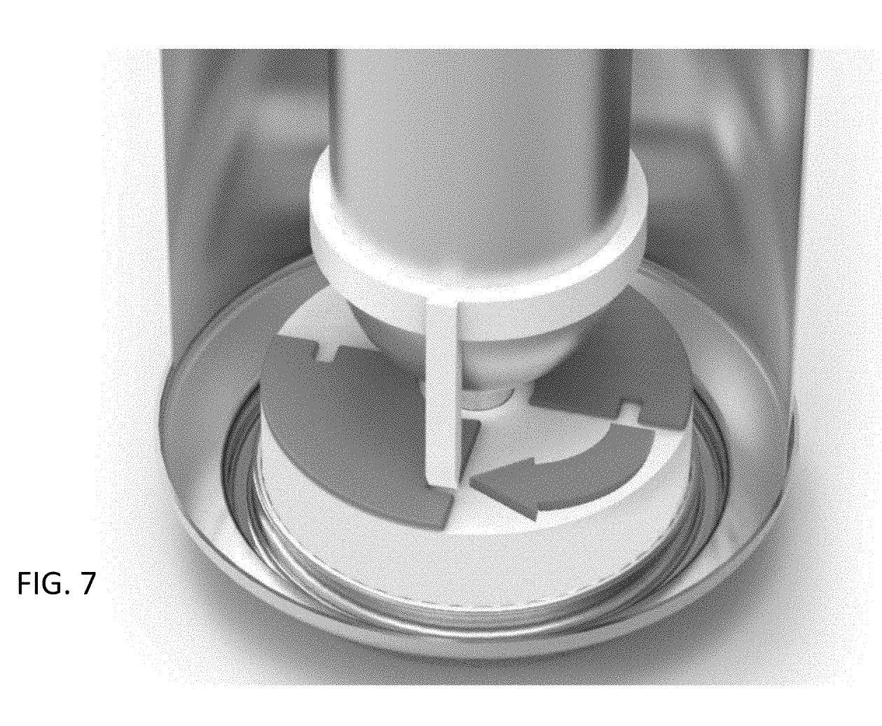

FIG. 4 shows can 401 with switch 402 and the various components inside the can in a closed and sealed configuration. FIG. 5 shows a cutaway view of the bottom of the can 501 showing trap cover 502 and ice trap 503 with all components in a closed, sealed state. Protrusions 504 and 505 are shown with two U-shaped openings in trap cover 502. FIG. 6 shows can 601 with switch 602 rotated approximately 90 degrees from the representation of FIG. 5, moving the protrusions, including protrusion 603, from one side of trap cover 604 to the other. The turning of the switch approximately 90 degrees opens the can and screws down the carbon dioxide cartridge or vessel, allowing the compressed carbon dioxide to escape the carbon dioxide cartridge and rush into the trap 605. Carbon dioxide is thus collected in the trap 605 and forms dry ice. An expanded view of this is shown in FIG. 7.

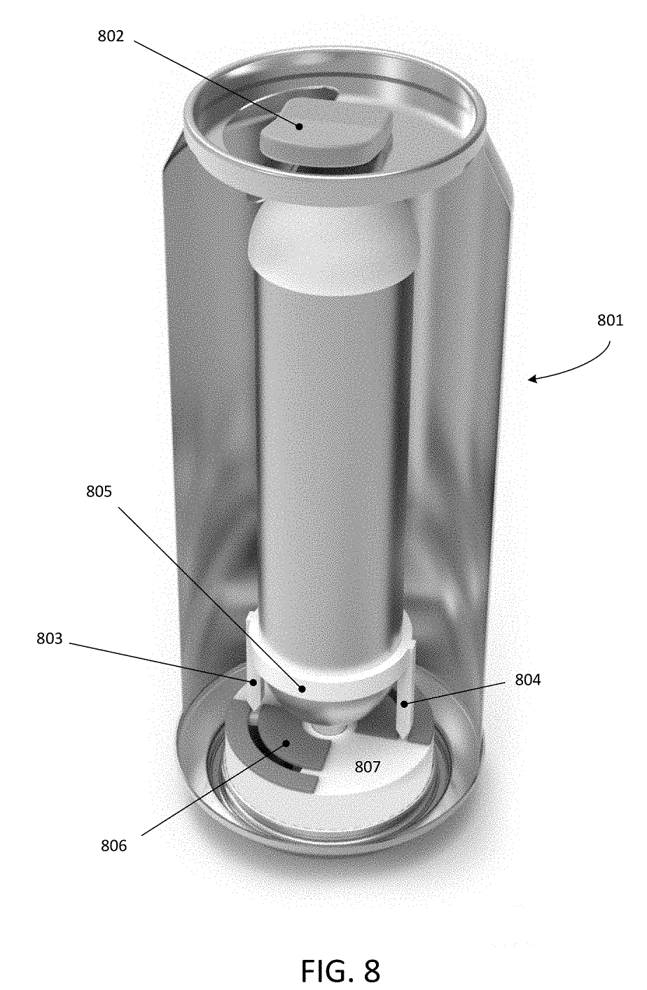

FIG. 8 illustrates further rotation of switch 802 atop can 801, with protrusions 803 and 804 on cutting ring 805 turned another approximately 90 degrees from the orientation shown in FIG. 6. As a result of this further rotation, protrusions 803 and 804 perforate or open trap cover 806, exposing the dry ice formed in the dry ice trap 807 to liquid or to atmosphere. Liquid may be added at a desired time to can 801 to produce the desired dry ice effect in the liquid.

An alternate embodiment of the present design joins trap cover to the rotating base of carbon dioxide cartridge 204, shown in detail in FIG. 3, wherein rotation of switch 202 atop can 201 rotates the various components beneath and the “doors” or “flaps” of the trap cover, thereby exposing the dry ice to the contents of the can 201. Such an embodiment would likely reduce and may eliminate the need for the cutting ring and protrusions but may require specialized and careful design of the dry ice trap and trap cover. In such a construction, design of the trap cover may vary and it may simply be a very small opening provided, i.e. a smaller portion of a circle than that shown in FIG. 2, for example. By way of example and not limitation, if the trap cover in FIG. 2 has a diameter of 1.5 inches, a trap cover that rotates rather than one perforated by protrusions may have a diameter of 0.75 inches, and rotation may expose a smaller sized opening. In such a design, a hole or set of holes of any dimension and number may be provided that when sealed, i.e. positioned over a hard exterior of the dry ice trap but, when rotated, positioned over an opening in the top of the dry ice trap. Enough time must be available to cause dry ice to form in the trap, and thus design of such a rotating trap cover muse allow dry ice to form, with limited exposure at an appropriate time. Other methods of exposing the dry ice formed in the trap may be employed, including release or opening at the base of the dry ice trap, or otherwise providing an opening in the dry ice trap. For example, compressed carbon dioxide may be provided to a device, such as a trap or other device, and the device may include a removable covering such that dry ice is formed and the removable covering removed, or holes may be punched into a bag or container, or any other method of adequately exposing the dry ice so formed to a liquid may be employed.

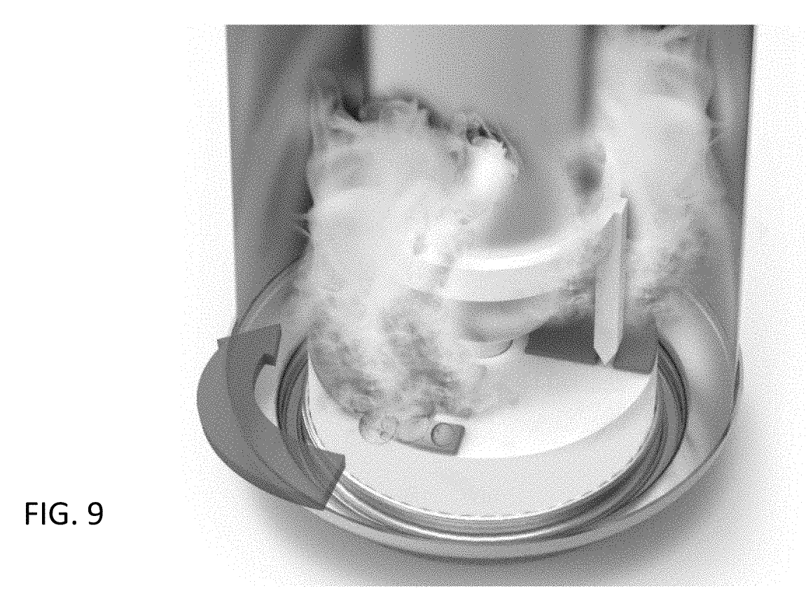

FIG. 9 shows the arrangement once the trap cover has been cut open in the embodiment presented. Cutting the trap cover to open the trap cover exposes the dry ice formed to liquid inside the can. The liquid inside bubbles and fog builds and exits the can via the opening formed by rotating the switch.

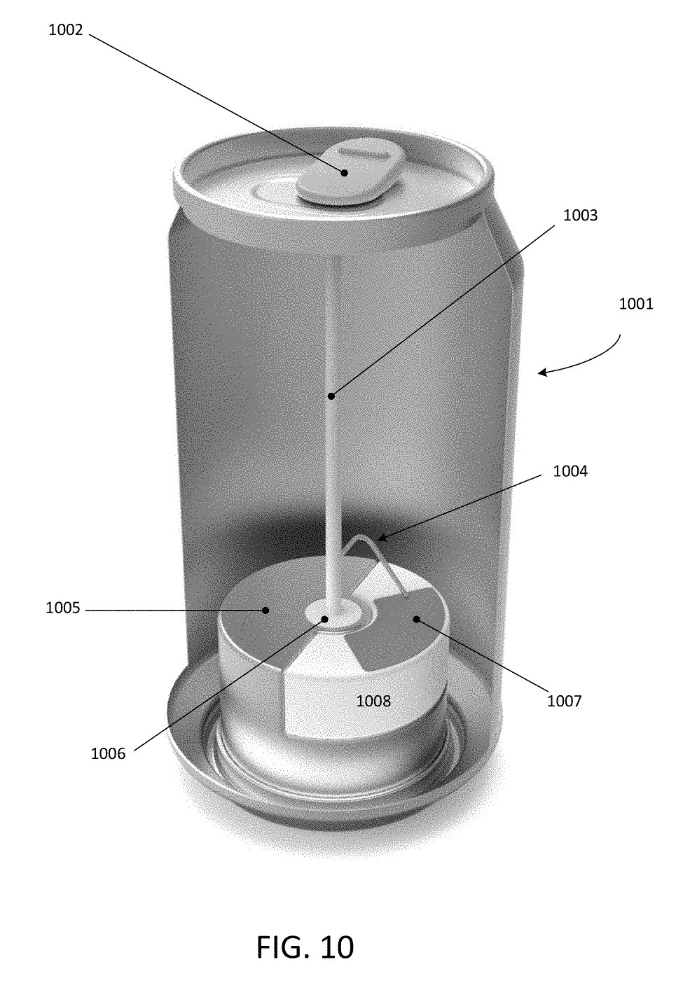

An alternate version of the present design is provided in FIGS. 10-17. From FIG. 10, there is provided can 1001, switch 1002 which is rotatable, rod 1003, pin 1004, carbon dioxide cartridge 1005, valve 1006, trap cover 1007, and carbon dioxide trap 1008. This arrangement provides for a container or vessel near the base of the can, with turning of the switch 1002 again causing both the formation of dry ice and exposure to the contents of the can, which typically contains liquid. Turning of the switch 1002 results in releasing pressurized carbon dioxide to a trap, such as carbon dioxide trap 1008 which differs in shape from the previous trap, as well as the pin scratching off or removing the trap cover 1007 to expose the dry ice formed.

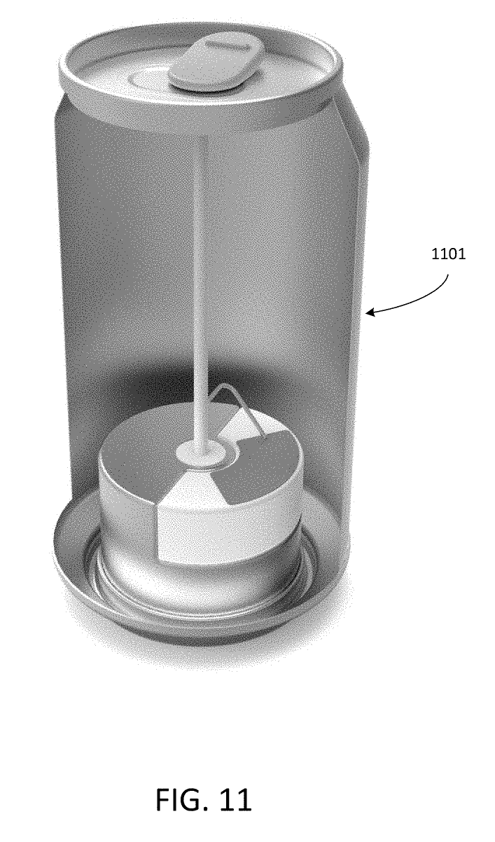

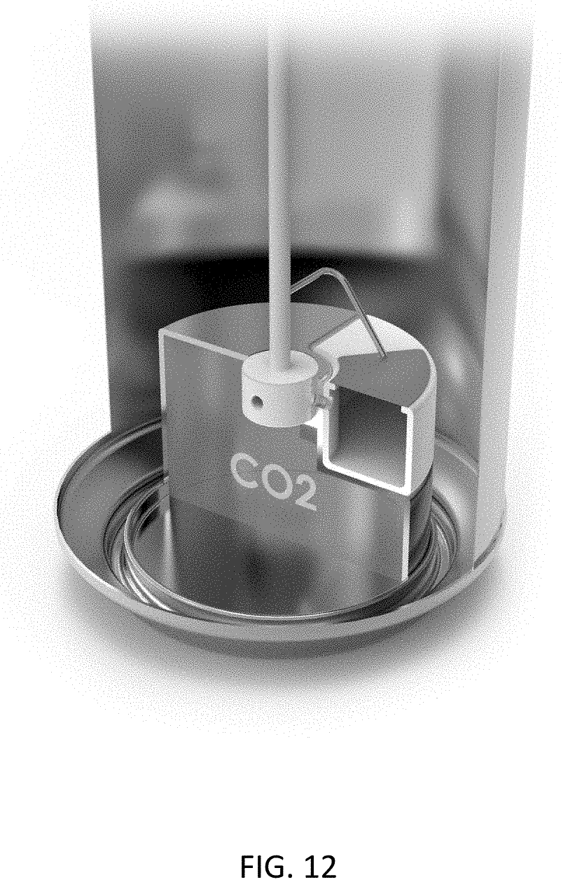

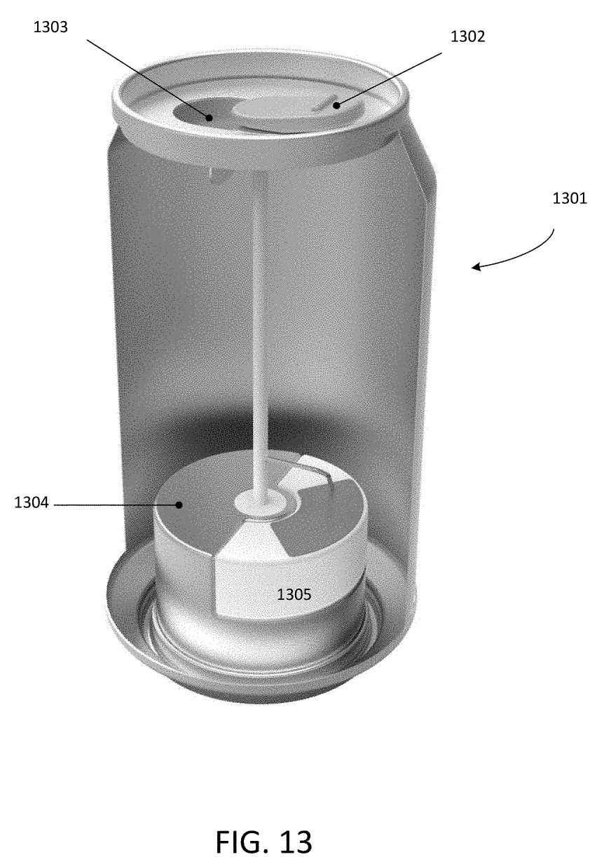

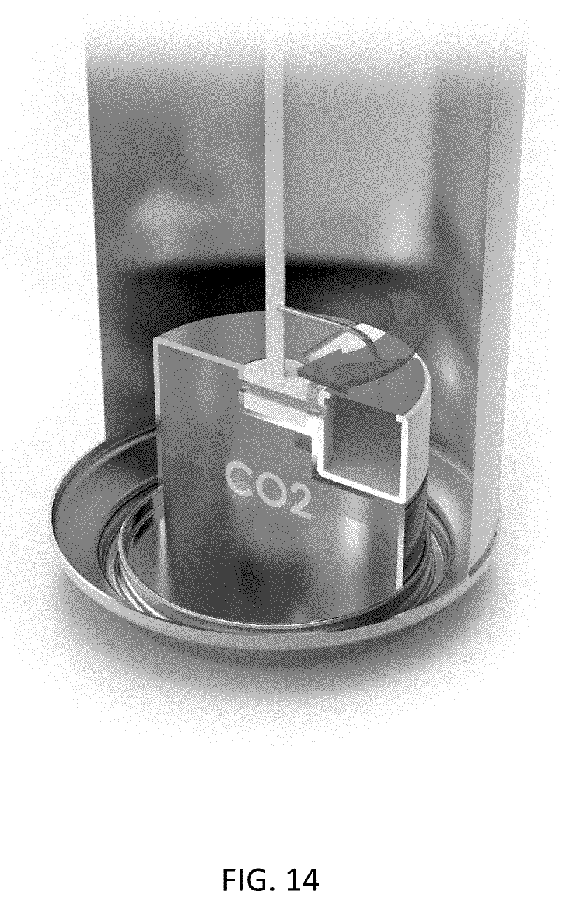

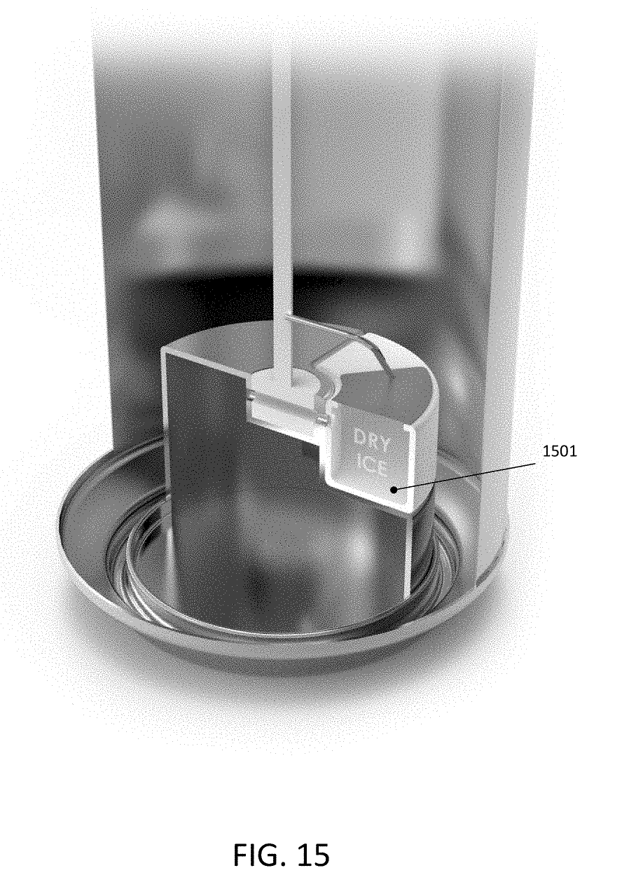

FIG. 11 shows the can 1101 and carbon dioxide sealed in the cartridge or vessel. FIG. 12 is a close view showing a cross section of the trap, trap cover, vessel/cartridge, and so forth. FIG. 13 shows can 1301 with switch 1302 turned approximately 90 degrees. The can is opened via an opening 1303 at the top, and such rotation breaks a seal, allowing carbon dioxide to escape the cartridge 1304 and enter the trap 305 whereby carbon dioxide collects in the trap 1305 and forms dry ice. FIG. 14 is a closer view showing the direction of rotation. FIG. 15 illustrates dry ice 1501 so formed.

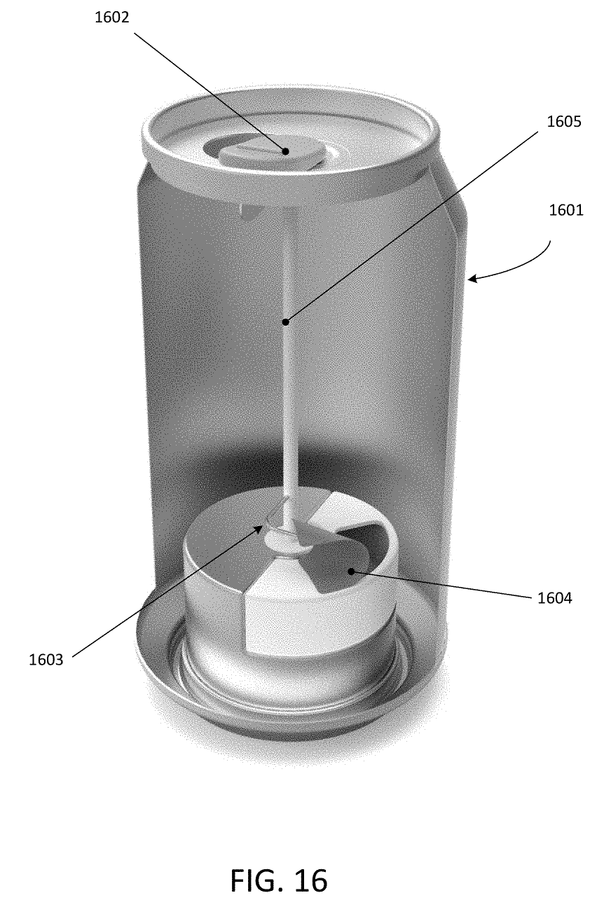

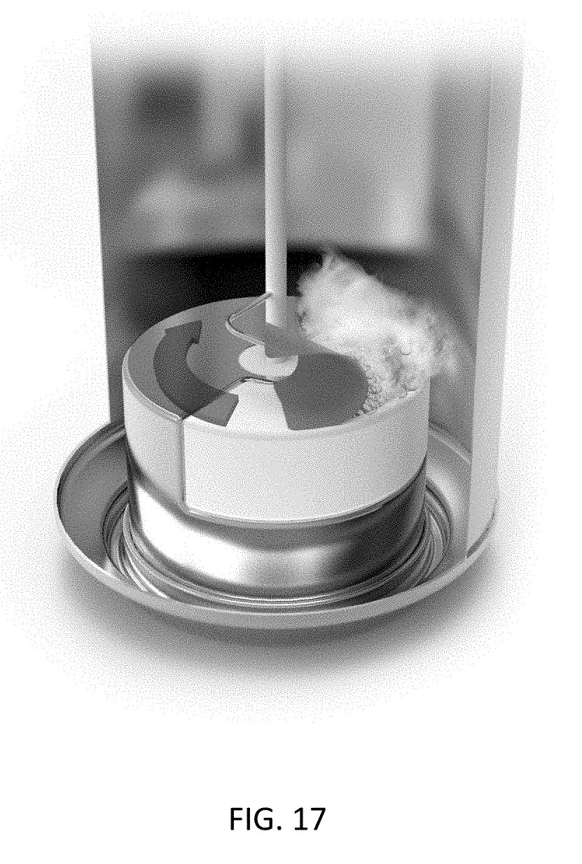

FIG. 16 shows can 1601 and switch 1602 turned an additional approximately 90 degrees, turning rod 1605 such that pin 1603 peels back trap cover 1604, exposing dry ice to liquid provided inside the can 1601. At this point, the liquid begins to bubble and fog begins to build and pour out of the can as shown in FIG. 17, which also shows the direction of rotation.

In its simplest form, the present design comprises an apparatus or vessel holding pressurized carbon dioxide and a trap that is filled with the compressed carbon dioxide from the vessel at a desired time, forming dry ice. At the same time or at a subsequent time, liquid is exposed to the dry ice so formed, producing the desired dry ice effect. All of the foregoing is typically provided in a single exterior vessel, such as an ordinary or slightly modified soda/beverage can.

Thus according to one embodiment, there is provided an apparatus comprising a vessel containing pressurized carbon dioxide, the vessel having a closed opening formed therein, a trap connected to the vessel wherein, when the closed opening in the vessel is opened, carbon dioxide passes into the trap, forming dry ice, and a trap covering positioned with the trap to be in a closed position and configured to be opened, thereby exposing the dry ice formed in the trap.

According to a second embodiment, there is provided a beverage can comprising a liquid, a vessel containing pressurized carbon dioxide, the vessel having a closed opening formed therein, a trap connected to the vessel wherein, when the closed opening in the vessel is opened, carbon dioxide passes into the trap, forming dry ice, and a trap covering positioned with the trap to be in a closed position and configured to be opened, thereby exposing the dry ice formed in the trap. The liquid is exposed to the dry ice when the trap covering is opened.

According to a further embodiment, a method for providing dry ice with a beverage is provided. Providing dry ice with the beverage comprises causing a vessel containing pressurized carbon dioxide to expel the pressurized carbon dioxide into a trap, thereby forming dry ice and opening the trap. Opening the trap exposes the dry ice formed to a liquid.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. An apparatus comprising:
a vessel containing pressurized carbon dioxide, the vessel having a closed opening formed therein;
a trap connected to the vessel wherein, when the closed opening in the vessel is opened, carbon dioxide passes into the trap, forming dry ice; and
a trap covering positioned with the trap to be in a closed position and configured to be opened, thereby exposing the dry ice formed in the trap.

2. The apparatus of claim 1, further comprising an opening device configured to cause an opening in the closed opening.

3. The apparatus of claim 1, further comprising an exterior container containing the vessel, the trap, and the trap cover, the exterior container configured to maintain liquid such that when the trap covering exposes the dry ice liquid contacts the dry ice.

4. The apparatus of claim 2, wherein the vessel comprises a series of threads such that when to vessel is rotated, the vessel turns and lowers via the series of threads thereby forcing the closed opening onto the opening device, causing the opening device to pierce the closed opening in the vessel.

5. The apparatus of claim 4, further comprising an exterior container containing the vessel, the trap, and the trap cover, and a rotatable switch provided on a top of the container rotatable by a user, wherein rotation of the rotatable switch causes the vessel to rotate and the opening device to pierce the closed opening in the vessel.

6. The apparatus of claim 5, further comprising a cutting ring having at least one protrusion, the cutting ring fixedly mounted to the vessel and the protrusions configured to cut the trap covering using movement of the vessel.

7. The apparatus of claim 2, wherein the opening device comprises a pin configured to puncture the closed opening.

8. The apparatus of claim 4, wherein the trap comprises a series of companion threads configured to receive the series of threads of the vessel.

9. A beverage can comprising:
a liquid;
a vessel containing pressurized carbon dioxide, the vessel having a closed opening formed therein;
a trap connected to the vessel wherein, when the closed opening in the vessel is opened, carbon dioxide passes into the trap, forming dry ice; and
a trap covering positioned with the trap to be in a closed position and configured to be opened, thereby exposing the dry ice formed in the trap;
wherein the liquid is exposed to the dry ice when the trap covering is opened.

10. The beverage can of claim 9, wherein the vessel is rotatable and the beverage can further comprises a rotatable switch configured to rotate the vessel.

11. The beverage can of claim 9, further comprising an opening device configured to cause an opening in the closed opening.

12. The beverage can of claim 11, wherein the vessel comprises a series of threads such that when to vessel is rotated, the vessel turns and lowers via the series of threads thereby forcing the closed opening onto the opening device, causing the opening device to pierce the closed opening in the vessel.

13. The beverage can of claim 10, wherein rotation of the rotatable switch causes the vessel to rotate and the opening device to pierce the closed opening in the vessel.

14. The beverage can of claim 9, further comprising a cutting ring having at least one protrusion, the cutting ring fixedly mounted to the vessel and the protrusions configured to cut the trap covering using movement of the vessel.

15. The beverage can of claim 11, wherein the opening device comprises a pin configured to puncture the closed opening.

16. A method for providing dry ice with a beverage, comprising:
causing a vessel containing pressurized carbon dioxide to expel the pressurized carbon dioxide into a trap, thereby forming dry ice; and
opening the trap;
wherein opening the trap exposes the dry ice formed to a liquid.

17. The method of claim 16, wherein causing the vessel containing the pressurized carbon dioxide to expel the pressurized carbon dioxide into the trap comprises puncturing a closed opening provided in the vessel.

18. The method of claim 16, wherein causing the vessel containing the pressurized carbon dioxide to expel the pressurized carbon dioxide into the trap comprises rotating the vessel above an opening device, causing the opening device to puncture a closed opening provided in the vessel.

19. The method of claim 16, wherein opening the trap comprises cutting an opening in a cover provided with the trap.

20. The method of claim 16, wherein causing the vessel containing the pressurized carbon dioxide to expel the pressurized carbon dioxide into the trap comprises a user moving the vessel.
